(19) United States
(12) Patent Application Publication
(10) Pub. No.: US 2008/0189546 A1
(43) Pub. Date: Aug. 7, 2008

(54) METHOD AND APPARATUS FOR PROVIDING AND USING CONTENT ALLOWING INTEGRITY VERIFICATION

(75) Inventor: Young-sun YOON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/854,176

(22) Filed: Sep. 12, 2007

(30) Foreign Application Priority Data
Feb. 5, 2007 (KR) 10-2007-0011823

(51) Int. Cl. H04L 9/00

(52) U.S. Cl. 713/168

(57) ABSTRACT

Provided are methods and apparatuses for providing and using content allowing integrity verification for determining whether the content has been altered. In the method of providing content allowing integrity verification, the content is divided into a plurality of parts, and integrity verification information for each of the plurality of parts is inserted into the content. Accordingly, it is possible to verify the integrity of the content transmitted even if the whole content file is not received and stored.

### CROSS-REFERENCE TO RELATED PATENT APPLICATIONS

This application claims priority from Korean Patent Application No. 10-2007-0011823, filed on Feb. 5, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to integrity verification for determining whether content has been altered during distribution of the content, and more particularly, to providing content allowing integrity verification and using the content, and an apparatus therefor.

2. Description of the Related Art

As the number of online content services has increased, content is distributed using various ways. Accordingly, it is possible that the content is forged or altered during the distribution thereof, thus increasing a need for a method of verifying whether the content has been forged or altered.

FIG. 1 is a diagram illustrating a content file in which a hash value has been inserted into a header 110 according to a related art method. Referring to FIG. 1, a hash value 111 obtained by applying a hash function to the whole content file that includes the header 110 and content 120 is inserted into the header 110. In order to verify the integrity of the content 120, a hash value first is calculated by applying the same hash function to the whole content file, and the hash value is compared with the hash value 111 extracted from the header 110. If the two hash values are equal to each other, it is determined that the content file has not been forged, and if they are not equal, it is determined that the content file has been forged.

FIG. 2 is a diagram illustrating content in which a hash value 211 is inserted into a license file 210 according to a related art method. Referring to FIG. 2, the hash value 211 of the whole content file 220 is calculated as described above with reference to FIG. 1, and is recorded in the license file 210 included in the content, together with the content file 220. A method of verifying the integrity of the content file is performed as described above with reference to FIG. 1.

The above method can be used when the whole content file is stored in a local storage device. Since the integrity of content is verified after receiving the whole content file, if content is reproduced while being received little by little via a streaming service, it is difficult to verify the integrity of the whole content file or a part of the content file before the reproduction.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for providing content by using integrity verification that can be effectively applied even during a content streaming service, and a method and apparatus for using the content.

According to an aspect of the present invention, there is provided a method of providing content allowing integrity verification, the method comprising dividing the content into a plurality of parts; and inserting integrity verification information for each of the parts of the content into the content.

The method may further include before transmitting each of the parts of the content, transmitting the integrity verification information corresponding to each of the parts.

The inserting of the integrity verification information may comprise respectively inserting hash values into the parts, where each of the hash values is calculated by applying a hash function to each of the parts.

The inserting of the hash values may comprise recording the hash values of the respective parts in a plurality of packets each having an identifier and transmitting the packets, when transmitting the content. Alternatively, the inserting of the hash values may comprise recording the hash values of the respective parts in a plurality of null packets and transmitting the null packets, when transmitting the content.

The inserting of the integrity verification information may comprise inserting a value obtained by encrypting secret information into each of the parts.

The method may further include providing information indicating locations where the integrity verification information for the respective parts is respectively inserted so as to allow a user of the content to detect the integrity verification information.

The providing of the information may comprise electronically signing the information regarding the locations with a secret key of a content provider.

The providing of the information may comprise recording the information regarding the locations in a header of the content. Alternatively, the providing of the information may include recording the information regarding the locations in a license file for the content.

The inserting of the value obtained by encrypting the secret information may comprise encrypting the secret information with a secret key of a content provider.

The method may further include providing information obtained by encrypting the secret key of the content with unique information of the user so as to allow the user of the content to obtain the secret key of the content provider.

The method may further include providing information obtained by encrypting the secret information with unique information of the user so as to allow the user of the content to determine whether the encrypted secret information has been altered.

According to another aspect of the present invention, there is provided a method of using content allowing integrity verification, the method comprising receiving content containing integrity verification information for each of a plurality of parts of the content; and verifying the integrity of each of the parts based on the integrity verification information.

The integrity verification information for each of the parts may comprise a first hash value that a content provider calculates by applying a hash function to each of the parts, and the verifying of the integrity of each of the parts comprises calculating a second hash value by applying a hash function to each of the parts; and comparing the first hash value with the second hash value.

The verifying of the integrity of each of the parts may comprise verifying the integrity of each of the parts when buffering of each of the parts by a play buffer is completed.

The integrity verification information for each of the parts may comprise first encrypted secret information obtained by the content provider encrypting secret information with a secret key. The verifying of each of the parts may comprise detecting and decrypting the first encrypted secret information from each of the parts; and determining whether the first encrypted secret information has been altered.

The method may further include receiving information regarding a plurality of locations where the integrity verification information for the respective parts are respectively inserted. The receiving of the information regarding the locations may comprise checking an electronic signature of the content provider applied to the information regarding the locations.

The method may further include receiving second encrypted secret information obtained by the content provider encrypting the secret information with unique information of the user, wherein the determining of whether the first encrypted secret information has been altered comprises comparing the result of decrypting the second encrypted secret information using the unique information of the user with the result of decrypting the first encrypted secret information.

The method may further include receiving information obtained by the content provider encrypting the secret key with the unique information of the user, wherein the decrypting of the first encrypted secret information comprises decrypting the first encrypted secret information using as a key the result of decrypting the received secret key encrypted using the unique information of the user.

According to another aspect of the present invention, there is provide an apparatus for providing content allowing integrity verification, the apparatus comprising an integrity verification information providing unit dividing the content into a plurality of parts and inserting integrity verification information for each of the parts into the content.

The apparatus may further include a content transmitting unit transmitting the integrity verification information for each of the parts before transmitting each of the parts.

According to another aspect of the present invention, there is provided an apparatus for using content allowing integrity verification, the apparatus comprising a content receiving unit receiving the content containing integrity verification information for each of parts of the content; a decoder decoding the received content and detecting the integrity verification information; and an integrity verification unit verifying the integrity of each of the parts based on the detected integrity verification information.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating content in which a hash value is inserted into a header according to a related art method;

FIG. 2 is a diagram illustrating content in which a hash value is inserted into a license file, according to a related art method;

FIG. 3 is a block diagram of an apparatus for providing content allowing integrity verification and an apparatus for using the content, according to an exemplary embodiment of the present invention;

FIG. 4 is a flowchart illustrating a method of providing content allowing integrity verification, according to an exemplary embodiment of the present invention;

FIG. 5 is a flowchart illustrating a method of using content allowing integrity verification, according to an exemplary embodiment of the present invention;

FIG. 6 is a diagram illustrating content in which a hash value is inserted into parts of content, according to an exemplary embodiment of the present invention

FIG. 7 is a diagram illustrating buffering of the content shown in FIG. 6 by using a play buffer, according to an exemplary embodiment of the present invention;

FIG. 8 is a diagram illustrating content in which encrypted secret information is inserted into each part, according to an exemplary embodiment of the present invention;

FIG. 9 is a block diagram illustrating a header of content, which contains information regarding a location where encrypted secret information is inserted, according to an exemplary embodiment of the present invention; and

FIG. 10 is a block diagram illustrating a license file that contains information regarding a location where encrypted secret information is inserted, according to an exemplary embodiment of the present invention.

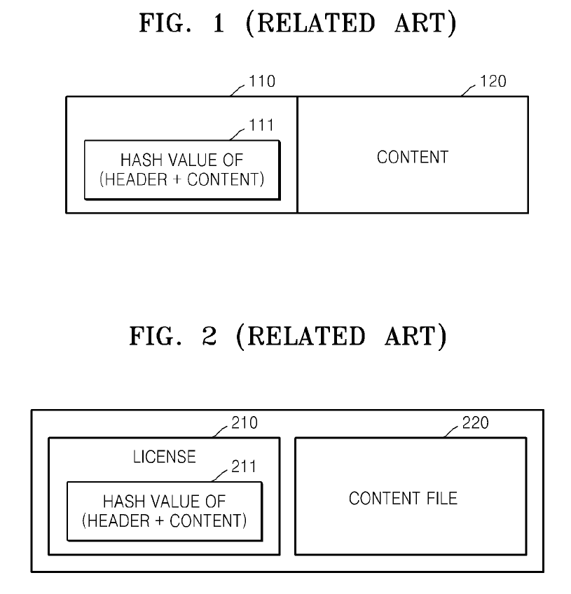

### DETAILED DESCRIPTION OF THE INVENTION

Hereinafter, the present invention will now be described more fully with reference to the accompanying drawings, in which exemplary embodiments of the invention are shown.

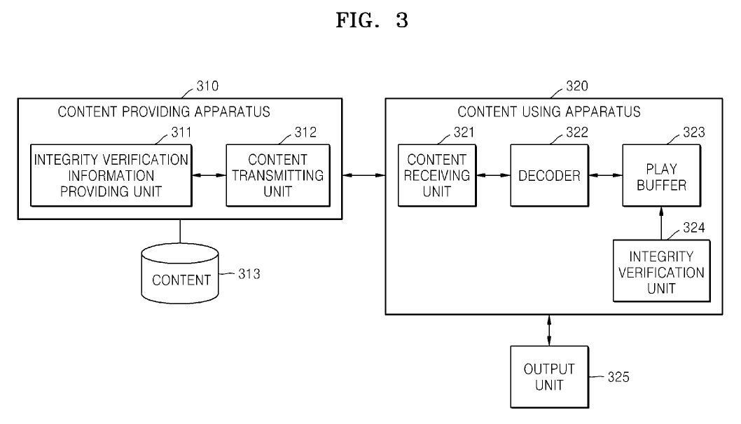

FIG. 3 is a block diagram of a content providing apparatus 310 for providing content allowing integrity verification and a content using apparatus 320 for using the content, according to an exemplary embodiment of the present invention. Referring to FIG. 3, the content providing apparatus 310 includes an integrity verification information providing unit 311 that divides content, which is to be provided, into a plurality of parts and inserts integrity verification information for each of the parts into the content. In order to transmit the content containing the integrity verification information to the content using apparatus 320, the content providing apparatus 310 may further include a content transmitting unit 312. The content transmitting unit 312 transmits the integrity verification information for each of the parts prior to transmitting each of the parts. However, the present invention is not limited to the above description. For example, one of the parts may be transmitted before transmission of its integrity verification information. In this case, the integrity verification information of the subsequent part must be transmitted prior to transmitting of a subsequent part so that the content using apparatus 320 can perform integrity verification on the one of the parts before it is reproduced.

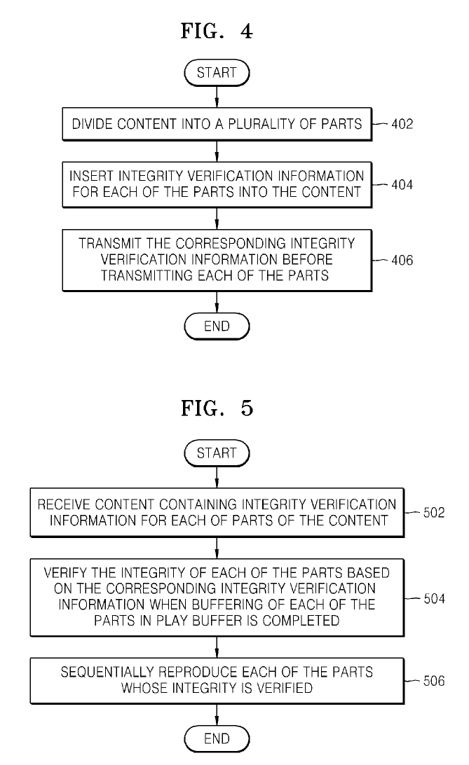

The content using apparatus 320 includes a content receiving unit 321 that receives content that contains integrity verification information for each part of the content, a decoder 322 that decodes the received content and detects the integrity verification information, and an integrity verification unit 324 that verifies the integrity of each of the parts based on the integrity verification information before reproduction of each of the parts. The content using apparatus 320 may further include a play buffer 323 that buffers data decoded by the decoder 322. In this case, the integrity verification unit 324 can verify the integrity of each part when buffering of each part by the play buffer 323 is completed. In an exemplary embodiment of the present invention, the part whose integrity has been verified is reproduced and output to the output unit 325. The content providing apparatus 310 and the content using apparatus 320 will now be described in greater detail with reference to FIGS. 4 through 10.

FIG. 4 is a flowchart illustrating a method of providing content allowing integrity verification, according to an exemplary embodiment of the present invention. Referring to FIGS. 3 and 4, the integrity verification information providing unit 311 divides a content file that is to be provided into a plurality of parts (operation 402). The content file may be divided into equal parts or unequal parts.

Next, the integrity verification information providing unit 311 inserts integrity verification information for each part into the respective part to which the information relates (operation 404). Thus, the integrity of each part can be verified even before receiving the whole content file. The integrity verification information for the respective parts may be different values or the same value. For example, the integrity verification information may be hash values obtained by respectively applying a hash function to the parts with an equal size. In this case, the hash values of the respective parts may be not the same.

In another exemplary embodiment of the present invention, a value obtained by encrypting predetermined secret information using a secret key received from a content provider may be inserted into each part. The content that has been generated or processed as described above may be transmitted to the content using apparatus 320 via the content transmitting unit 312, by using a streaming service or the like. In this case, the corresponding integrity verification information is transmitted before transmitting each part (operation 406).

FIG. 5 is a flowchart illustrating a method of using content allowing integrity verification, according to an exemplary embodiment of the present invention. Referring to FIGS. 3 and 5, the content receiving unit 321 of the content using apparatus 320 receives content containing integrity verification information from the content providing apparatus 310 (operation 502). During a streaming service, content is reproduced while being received little by little. When buffering of each part of the content decoded by the decoder 322 in the play buffer 323 is completed, the integrity verification unit 324 verifies the integrity of each part based on the respective integrity verification information for each part so as to determine whether to start reproduction of a subsequent part after reproduction of the part preceding the subsequent part (operation 504). In other words, if integrity verification of a part fails, that is, if a part is determined to be forged or altered, the reproduction of the part is stopped, and if the integrity verification of parts continuously succeeds, the parts are sequentially reproduced (operation 506). If a hash value is used as the integrity verification information, the hash value is calculated by applying a hash function that a content provider has used to each part of the content, and is compared with a hash value extracted from the content. If the result of encrypting secret information is used as the integrity verification information, it is determined whether the result is extracted from each part. If the result is extracted, the secret information is obtained by decrypting the result, and it is determined whether the secret information is a correct value that has not been altered.

FIG. 6 is a diagram illustrating content in which a hash value is inserted into parts of content, according to an exemplary embodiment of the present invention. In the current exemplary embodiment, the content file is divided into appropriate parts, and a hash value is calculated by applying a hash function to each of the parts (not to the whole content file) and inserted between the parts (not into a header of or a license file of the content). In the current exemplary embodiment, the content file is divided into equal parts, but the present invention is not limited thereto. That is, the content file may be divided into unequal parts, and in this case, information regarding a location into which each hash value is inserted is provided together with content so that a receiving side can extract each hash value. Content may be divided into units of Groups of Pictures (GOPs), but the present invention is not limited thereto. However, in order to calculate a hash value for each part of the content in a time efficient manner, the units into which the content is divided is preferably smaller than the size of a play buffer. Referring to FIG. 6, content is divided into n parts C₁ 621, C₂ 622, C₃ 623, through to Cₙ; and n hash values h(C₁)611, h(C₂) 612, h(C₃) 613, through to h(Cₙ), which are calculated for the respective parts C₁ 621, C₂ 622, C₃ 623, through to Cₙ, are respectively inserted before the parts C₁ 621, C₂ 622, C₃ 623, through to Cₙ.

When content is transmitted, calculated hash values may be inserted into the content by defining and using a new packet containing the hash values or by using the existing packets. Since a new packet can be defined according to standards, such as the Moving Picture Experts Group (MPEG) standard, packets each having a identifier indicating inclusion of a hash value are defined, and the packets each containing the hash value are transmitted before transmitting packets each containing one part of the content. In order to use the existing packets, null packets may be used. When content is transmitted, hash values for the respective parts of the content are recorded in a plurality of null packets and the null packets are transmitted in the order illustrated in FIG. 6.

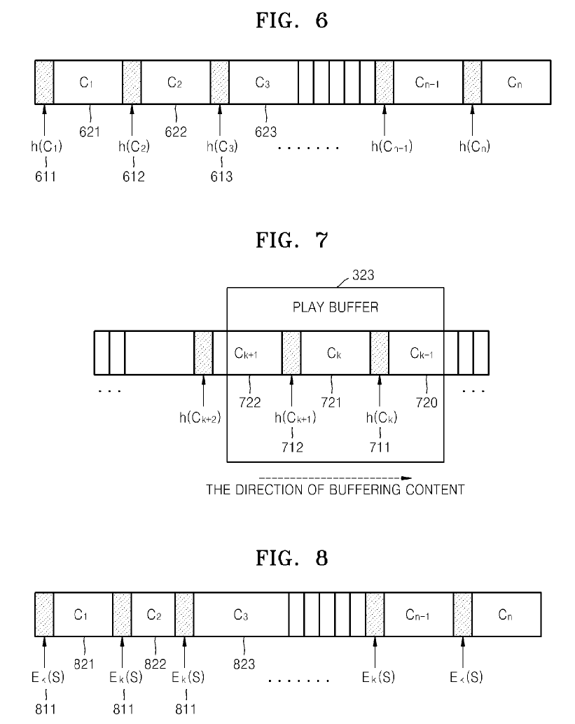

FIG. 7 is a diagram illustrating buffering of the content shown in FIG. 6 by using a play buffer 323, according to an exemplary embodiment of the present invention. Referring to FIG. 7, the end of a content part Cₖ₋₁ 720 to the head of a content part C_{K+1} 722 is buffered in the play buffer 323. If the content part Cₖ₋₁ 720 is being reproduced and the whole subsequent content part Cₖ 721 remains in the play buffer 323 together with the corresponding hash value h(Cₖ) 711, integrity verification is performed on Cₖ 721. That is, a hash value of the content part Cₖ 721 is calculated, inserted into the content, and compared with the hash value h(Cₖ) 711. If the two hash values are different from each other, the content part Cₖ 721 is forged and thus, reproduction of the content part Cₖ 721 is not performed. If the two hash values are the same, the content part Cₖ 721 is continuously reproduced, and integrity verification is performed on the content part C_{K+1} 722 when both the content part C_{K+1} 722 and its hash value h(Cₖ₊₁) 712 are completely buffered in the play buffer 323.

FIG. 8 illustrates encrypted secret information inserted into each content part, according to an exemplary embodiment of the present invention. Referring to FIG. 8, content is divided into n parts: C₁ 821, C₂ 822, C₃ 823, through to Cₙ, and Eₖ(S) 811, which is obtained by encrypting predetermined secret information S as integrity verification information with a key k, is inserted before the content part C₁ 821, C₂ 822, C₃ 823, through to Cₙ. As described above with reference to FIG. 7, an instant of time when integrity verification is performed can also be applied to the current exemplary embodiment of the present invention. In the current exemplary embodiment, a content file is divided into unequal parts. In this case, the integrity verification information providing unit 311 must provide location information indicating where each of the integrity verification information is inserted so that the content using apparatus 320 can detect the integrity verification information.

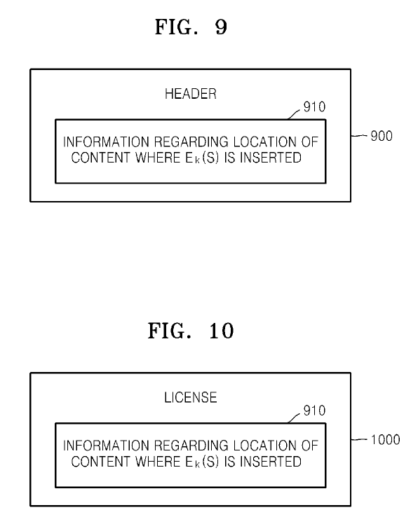

FIG. 9 is a block diagram illustrating a header 900 of content, which contains information 910 regarding a location where encrypted secret information is inserted, according to an exemplary embodiment of the present invention. FIG. 10 is a block diagram illustrating a license file 1000 that contains information 910 regarding a location where encrypted secret information is inserted, according to an exemplary embodiment of the present invention. In order to prove that the information 910 is provided by the content providing apparatus 310, the information 910 may be electronically signed using a secret key of a content provider. Providing of the information 910 described with reference to FIGS. 9 and 10 can also be applied to an exemplary embodiment of the present invention that uses a hash value.

The integrity verification information providing unit 311 inserts each value Eₖ(S), which is obtained by encrypting certain secret information S with a secret key k, into content that is to be provided, electronically signs information indicating the location of each value Eₖ(S) by using the secret key k, and provides the result of signing to the content using apparatus 320. The content using apparatus 320 can determine that the information has been provided by a content provider by checking the result of signing. As described above, the information 910 may be inserted into the head of the content or into a license necessary to use the content.

The secret key k used to calculate the value Eₖ(S) is encrypted using unique information u identifying a user when the content is provided to the user in accordance with the user's request. The unique information may be a public key u that is uniquely allocated to the user. It is assumed that the value obtained by encrypting the secret key k using the unique information u is Eᵤ(k). The value Eᵤ(k) is transmitted separately or together with the content so that the user can obtain the secret key k of the content provider. For example, the value Eᵤ(k) may be inserted into a license that is to be transmitted. Since the value Eᵤ(k) has been encrypted, nobody except the authorized user can decrypt it, and therefore, the value Eᵤ(k) may be transmitted together with the content. Also, a value Eᵤ(S) obtained by encrypting the secret information S, which is inserted into the content, by using the unique information u may be inserted into the license that is to be provided to the user. In this case, similarly to the value Eᵤ(k), the value Eᵤ(S) may be transmitted using various ways to the user without being inserted into the license. Since the user can obtain the secret information S, which is provided from the content provider, by decrypting the value Eᵤ(S), the user can determine whether the secret information inserted into the content has been altered.

The integrity verification unit 324 calculates the key k and the secret information S by decrypting the values Eᵤ(k) and Eᵤ(S) received from the content providing apparatus 310 by using the unique information u. Also, the integrity verification unit 324 determines whether the encrypted secret information Eₖ(S) is detected at all locations specified in location information received from the content providing apparatus 310 while receiving and reproducing the content, and decrypts the value Eₖ(S) using the key k. Next, the integrity verification unit 324 determines whether the result of decrypting the value Eₖ(S) is identical to the calculated secret information S in order to check the integrity of the content.

The method as described above, according to the present invention, can be embodied as computer readable code in a computer readable medium.

As described above, according to the present invention, it is possible to verify the integrity of content even during streaming of the content. That is, even if the whole content file is not received and stored, it is possible to verify the integrity of content transmitted, thereby allowing a user to conveniently use the content.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing content allowing integrity verification, the method comprising:
dividing the content into a plurality of parts; and
inserting integrity verification information for each of the plurality of parts of the content into the content.

2. The method of claim 1, further comprising, transmitting the integrity verification information corresponding to each of the plurality of parts.

3. The method of claim 1, wherein the inserting of the integrity verification information comprises inserting hash values into the plurality of parts, wherein each of the hash values is calculated by applying a hash function to each of the plurality of parts.

4. The method of claim 3, wherein the inserting of the hash values comprises recording the hash values of the plurality of parts in a plurality of packets each having an identifier and transmitting the packets, when transmitting the content.

5. The method of claim 3, wherein the inserting of the hash values comprises recording the hash values of the plurality of parts in a plurality of null packets and transmitting the plurality of null packets along with the content.

6. The method of claim 1, wherein the inserting of the integrity verification information comprises inserting a value obtained by encrypting secret information into each of the plurality of parts.

7. The method of claim 1, further comprising providing information indicating a plurality of locations where the integrity verification information for each of the plurality of parts is inserted so as to allow a user of the content to detect the integrity verification information.

8. The method of claim 7, wherein the providing of the information comprises electronically signing the information indicating the plurality of locations with a secret key of a provider of the content.

9. The method of claim 7, wherein the providing of the information comprises recording the information indicating the plurality of locations in a header of the content.

10. The method of claim 7, wherein the providing of the information comprises recording the information indicating the plurality of locations in a license file for the content.

11. The method of claim 6, wherein the inserting of the value obtained by encrypting the secret information comprises encrypting the secret information with a secret key of a provider of the content.

12. The method of claim 11, further comprising providing information obtained by encrypting the secret key of the provider of the content with unique information of a user so as to allow the user of the content to obtain the secret key of the provider of the content.

13. The method of claim 6, further comprising providing information obtained by encrypting the secret information with unique information of a user so as to allow the user of the content to determine whether the encrypted secret information has been altered.

14. A method of using content allowing integrity verification, the method comprising:
receiving the content containing integrity verification information for each of a plurality of parts of the content; and
verifying integrity of each of the plurality of parts based on the integrity verification information.

15. The method of claim 14, wherein the integrity verification information for each of the plurality of parts comprises a first hash value that a provider of the content calculates by applying a hash function to each of the parts, and
the verifying of the integrity of each of the plurality of parts comprises:
calculating a second hash value by applying a hash function to each of the plurality of parts; and
comparing the first hash value with the second hash value.

16. The method of claim 14, wherein the verifying of the integrity of each of the plurality of parts comprises verifying the integrity of each of the plurality of parts when buffering of each of the plurality of parts by a play buffer is completed.

17. The method of claim 14, wherein the integrity verification information for each of the parts comprises first encrypted secret information obtained by the provider of the content encrypting secret information with a secret key, and
the verifying of each of the plurality of parts comprises:
detecting and decrypting the first encrypted secret information from each of the plurality of parts; and
determining whether the first encrypted secret information has been altered.

18. The method of claim 14, further comprising receiving information indicating a plurality of locations where the integrity verification information for the plurality of parts are inserted.

19. The method of claim 18, wherein the receiving of the information indicating the plurality of locations comprises checking an electronic signature of the provider of the content applied to the information indicating the plurality of locations.

20. The method of claim 17, further comprising receiving a second encrypted secret information obtained by the provider of the content encrypting the secret information with unique information of a user,
wherein the determining of whether the first encrypted secret information has been altered comprises comparing a result of decrypting the second encrypted secret information using the unique information of the user with a result of the decrypting the first encrypted secret information.

21. The method of claim 17, further comprising receiving information obtained by the provider of the content encrypting the secret key with unique information of a user,
wherein the decrypting of the first encrypted secret information comprises decrypting the first encrypted secret information using as a key a result of decrypting the secret key encrypted using the unique information of the user.

22. An apparatus for providing content allowing integrity verification, the apparatus comprising:
an integrity verification information providing unit which divides the content into a plurality of parts and inserts integrity verification information for each of the plurality of parts into the content.

23. The apparatus of claim 22, further comprising a content transmitting unit which transmits the integrity verification information for each of the plurality of parts.

24. The apparatus of claim 22, wherein the integrity verification information providing unit inserts hash values into each of the plurality of parts, wherein the hash values are calculated by applying a hash function to each of the plurality of parts.

25. The apparatus of claim 24, wherein the integrity verification information providing unit records the hash values of the plurality of parts in a plurality of packets each having an identifier, when transmitting the content.

26. The apparatus of claim 24, wherein the integrity verification information providing unit records the hash values of the plurality of parts in a plurality of null packets, when transmitting the content.

27. The apparatus of claim 22, wherein the integrity verification information providing unit inserts a value obtained by encrypting secret information into each of the plurality of parts.

28. The apparatus of claim 22, wherein the integrity verification information providing unit generates information indicating a plurality of locations where the integrity verification information for each of the plurality of parts is inserted so as to allow a user of the content to detect the integrity verification information.

29. The apparatus of claim 28, wherein the integrity verification information providing unit electronically signs the information indicating the plurality of locations using a secret key of a provider of the content.

30. The apparatus of claim 28, wherein the integrity verification information providing unit records the information indicating the plurality of locations in a header of the content.

31. The apparatus of claim 28, wherein the integrity verification information providing unit records the information indicating the plurality of locations in a license file of the content.

32. The apparatus of claim 27, wherein the integrity verification information providing unit encrypts the secret information using a secret key of a provider of the content.

33. The apparatus of claim 32, wherein the integrity verification information providing unit provides information obtained by encrypting the secret key of the provider of the content with unique information of a user so as to allow the user to obtain the secret key of the provider of the content.

34. The apparatus of claim 27, wherein the integrity verification information providing unit provides information obtained by encrypting the secret information with unique information of a user so as to allow the user to determine whether the encrypted secret information has been altered.

35. An apparatus for using content allowing integrity verification, the apparatus comprising:
a content receiving unit which receives the content containing integrity verification information for each of a plurality of parts of the content;
a decoder which decodes the received content and detects the integrity verification information; and
an integrity verification unit which verifies integrity of each of the plurality of parts based on the detected integrity verification information.

36. The apparatus of claim 35, wherein the integrity verification information for each of the plurality of parts comprises a first hash value calculated by applying a hash function to each of the plurality of parts by the provider of the content, and
the integrity verification unit calculates a second hash value by applying a hash function to each of the plurality of parts, and compares the first hash value with the second hash value.

37. The apparatus of claim 35, further comprising a play buffer buffering data decoded by the decoder,
wherein the integrity verification unit verifies the integrity of each of the plurality of parts when buffering of each of the plurality of parts in the play buffer is completed.

38. The apparatus of claim 35, wherein the integrity verification information for each of the plurality of parts comprises first encrypted secret information obtained by encrypting secret information with a secret key by a provider of the content, and
the integrity verification unit detects and decrypts the first encrypted secret information from each of the plurality of parts, and determines whether the first encrypted secret information has been altered.

39. The apparatus of claim 35, wherein the content receiving unit receives information indicating a plurality of locations where the integrity verification information for the respective parts is inserted.

40. The apparatus of claim 39, wherein the integrity verification unit checks an electronic signature of the provider of the content, which is applied to the information indicating the plurality of locations.

41. The apparatus of claim 38, wherein the content receiving unit receives second encrypted secret information obtained by encrypting the secret information with unique information of the user by the content provider, and
the integrity verification unit compares a result of decrypting the second encrypted secret information using the unique information of the user with a result of the decrypting the first encrypted secret information.

42. The apparatus of claim 38, wherein the content receiving unit receives information obtained by encrypting the secret key using the unique information of the user by the provider of the content, and
the integrity verification unit decrypts the first encrypted secret information by using as a key a result of decrypting the secret key that was encrypted using the unique information of the user.

43. A computer readable medium having recorded thereon a computer program for executing a method of providing content allowing integrity verification, the method comprising:
dividing the content into a plurality of parts; and
inserting integrity verification information for each of the plurality of parts of the content into the content.

44. A computer readable medium having recorded thereon a computer program for executing the method of using content allowing integrity verification, the method comprising:
receiving the content containing integrity verification information for each of a plurality of parts of the content; and
verifying integrity of each of the plurality of parts based on the integrity verification information.
